(19) United States
(12) Patent Application Publication
(10) Pub. No.: US 2015/0131115 A1
(43) Pub. Date: May 14, 2015

(54) IMAGE FORMING APPARATUS, IMAGE FORMING SYSTEM, AND IMAGE FORMING METHOD

(71) Applicant: KYOCERA Document Solutions Inc., Osaka (JP)

(72) Inventor: Tomoaki Nakaizawa, Osaka (JP)

(21) Appl. No.: 14/535,230

(22) Filed: Nov. 6, 2014

(30) Foreign Application Priority Data
Nov. 11, 2013 (JP) 2013-232775

(51) Int. Cl. G06F 3/12

(52) U.S. Cl. CPC G06F 3/121; G06F 3/1234
USPC 358/1.14; 358/1.15

(57) ABSTRACT

An image forming apparatus includes a receiving portion, a print control portion, a first detection portion, and a transmission control portion. The receiving portion receives, from an information processing apparatus, print data to which predetermined transmission destination information has been added. The print control portion executes a print process based on the print data. The first detection portion detects a mobile terminal that exists in a predetermined communication range and is identified based on the transmission destination information added to the print data. The transmission control portion, when the first detection portion detects the mobile terminal, transmits the print data, which is associated with the mobile terminal, to the mobile terminal.

### INCORPORATION BY REFERENCE

This application is based upon and claims the benefit of priority from the corresponding Japanese Patent Application No. 2013-232775 filed on Nov. 11, 2013, the entire contents of which are incorporated herein by reference.

### BACKGROUND

The present disclosure relates to an image forming apparatus that executes a print process based on the print data.

In image forming systems for performing printing by transmitting print data from an information processing apparatus such as a personal computer to an image forming apparatus, there may be a case where the print process is interrupted due to a failure such as a paper jam having occurred to the image forming apparatus. There is known an image forming system in which, after the image forming apparatus is recovered from the failure, the print process is resumed from a not-processed part. There is also known an image forming system in which not-processed print data is transmitted to another specified image forming apparatus, and the print process is resumed therein.

### SUMMARY

An image forming apparatus according to an aspect of the present disclosure includes a receiving portion, a print control portion, a first detection portion, and a transmission control portion. The receiving portion receives, from an information processing apparatus, print data to which predetermined transmission destination information has been added. The print control portion executes a print process based on the print data. The first detection portion detects a mobile terminal that exists in a predetermined communication range and is identified based on the transmission destination information added to the print data. The transmission control portion, when the first detection portion detects the mobile terminal, transmits the print data, which is associated with the mobile terminal, to the mobile terminal.

An image forming system according to another aspect of the present disclosure includes an image forming apparatus and an information processing apparatus. The image forming apparatus includes: a receiving portion configured to receive, from an information processing apparatus, print data to which predetermined transmission destination information has been added; a print control portion configured to execute a print process based on the print data; a first detection portion configured to detect a mobile terminal that exists in a predetermined communication range and is identified based on the transmission destination information added to the print data; and a transmission control portion configured to, when the first detection portion detects the mobile terminal, transmit the print data, which is associated with the mobile terminal, to the mobile terminal. The information processing apparatus includes a first transmission portion configured to add, to the print data, the transmission destination information of the mobile terminal having been set in advance, and transmit the print data to the image forming apparatus.

An image forming method according to a further aspect of the present disclosure includes a receiving step, a printing step, a detecting step, and a transmitting step. The receiving step receives, from an information processing apparatus, print data to which predetermined transmission destination information has been added. The printing step executes a print process based on the print data. The detecting step detects a mobile terminal that exists in a predetermined communication range and is identified based on the transmission destination information added to the print data. The transmitting step, when the detecting step detects the mobile terminal, transmits the print data, which is associated with the mobile terminal, to the mobile terminal.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an outlined configuration diagram showing an image forming system according to an embodiment of the present disclosure.

FIG. 2 is an outlined configuration diagram showing an image forming apparatus according to an embodiment of the present disclosure.

FIG. 3 is a flowchart showing an example of the first transmission process executed in an information processing apparatus according to an embodiment of the present disclosure.

FIG. 4 is a flowchart showing an example of the transmission control process executed in the image forming apparatus according to an embodiment of the present disclosure.

FIG. 5 is a flowchart showing an example of the second transmission process executed in a mobile terminal according to an embodiment of the present disclosure.

### DETAILED DESCRIPTION

The following describes an embodiment of the present disclosure with reference to the drawings, for the understanding of the disclosure. It should be noted that the following description is an example of an embodiment of the present disclosure and should not limit the technical scope of the present disclosure.

[Image Forming System 100]

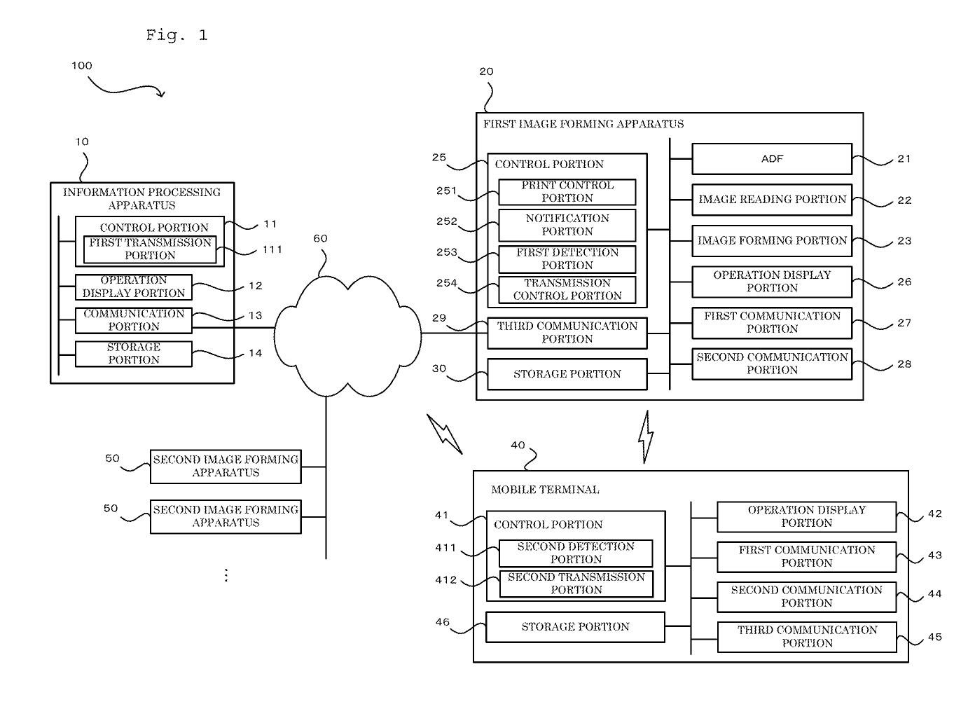

As shown in FIG. 1, an image forming system 100 according to an embodiment of the present disclosure includes an information processing apparatus 10, a first image forming apparatus 20, a mobile terminal 40, and one or more second image forming apparatuses 50. The information processing apparatus 10, first image forming apparatus 20, mobile terminal 40, and second image forming apparatuses 50 are connectable via a communication network 60 such as the Internet, LAN, or the like. In addition, the first image forming apparatus 20 and the mobile terminal 40 can communicate with each other based on a wireless communication standard for Bluetooth (registered trademark). Furthermore, the first image forming apparatus 20 and the mobile terminal 40 can communicate with each other based on a wireless communication standard for NFC (Near Field Communication).

[Information Processing Apparatus 10]

As shown in FIG. 1, the information processing apparatus 10 is a personal computer or the like that includes a control portion 11, an operation display portion 12, a communication portion 13, and a storage portion 14. It is noted that the information processing apparatus 10 may be a smartphone, a mobile telephone, a tablet terminal, a PDA, or the like.

The control portion 11 includes control equipment (not shown) such as CPU, ROM, RAM, EEPROM, or the like. The CPU is a processor for executing various types of arithmetic processes. The ROM is a nonvolatile storage portion in which various types of information such as control programs for causing the CPU to execute various types of processes are stored in advance. The RAM is a volatile storage portion, and the EEPROM is a nonvolatile storage portion. The RAM and the EEPROM are used as a temporary storage memory (working area) for the various types of processes executed by the CPU. The control portion 11 comprehensively controls the image processing apparatus 10 by causing the CPU to execute the various types of control programs that have been stored in advance in the ROM or the storage portion 14. It is noted that the control portion 11 may be formed as an electronic circuit such as an integrated circuit (ASIC).

The operation display portion 12 includes a display portion and an operation portion. The display portion is, for example, a liquid crystal display and displays various types of information based on control instructions from the control portion 11. The operation portion is composed of, for example, a keyboard and a mouse through which various types of input operations are received from the user.

The communication portion 13 executes a wired or wireless data communication with an external communication apparatus such as the first image forming apparatus 20, via the communication network 60.

The storage portion 14 is a storage portion such as a SSD (Solid State Drive) or a HDD (Hard Disk Drive), and data is read therefrom or written thereto by the control portion 11. In addition, the storage portion 14 can store print data that is printed by the first image forming apparatus 20.

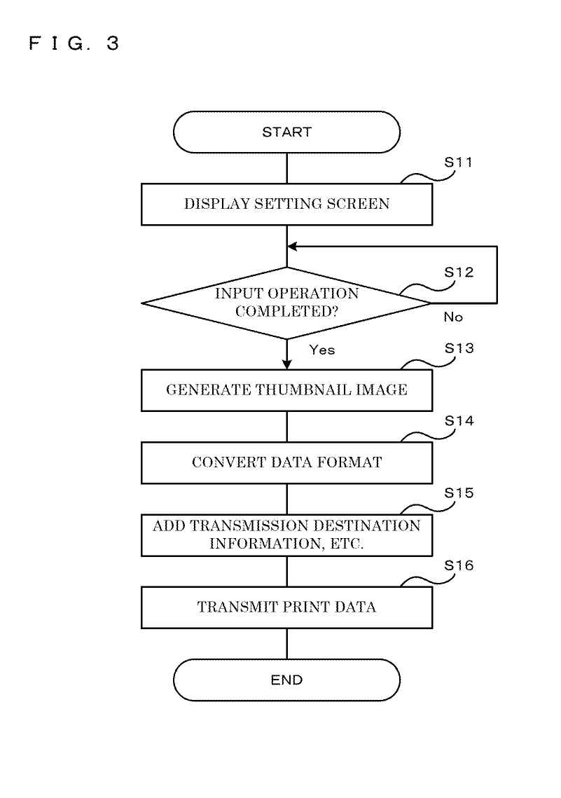

Furthermore, a first transmission program is stored in the storage portion 14 in advance, wherein the first transmission program is used to cause the control portion 11 to execute a first transmission process (see the flowchart of FIG. 3) that is described below. It is noted that the first transmission program may be recorded in a computer-readable recording medium such as a CD, a DVD, a flash memory, or the like, and may be installed from the recording medium into a storage portion such as the storage portion 14.

As shown in FIG. 1, the control portion 11 includes a first transmission portion 111. The control portion 11 functions as the first transmission portion 111 when it executes, by using the CPU, the first transmission program stored in the storage portion 14.

The first transmission portion 111 transmits the print data to the first image forming apparatus 20 by associating the print data with a predetermined mobile terminal, which is, in this example, the mobile terminal 40. Specifically, the first transmission portion 111 associates the mobile terminal 40 with the print data by adding transmission destination information which identifies the mobile terminal 40, to the header information or the like of the print data. For example, the transmission destination information is an electronic mail address of the mobile terminal 40. Alternatively, the transmission destination information may be a MAC address, an IP address, a paring ID (which is described below) that are information used in the communication network 60 to identify the mobile terminal 40.

[First Image Forming Apparatus 20]

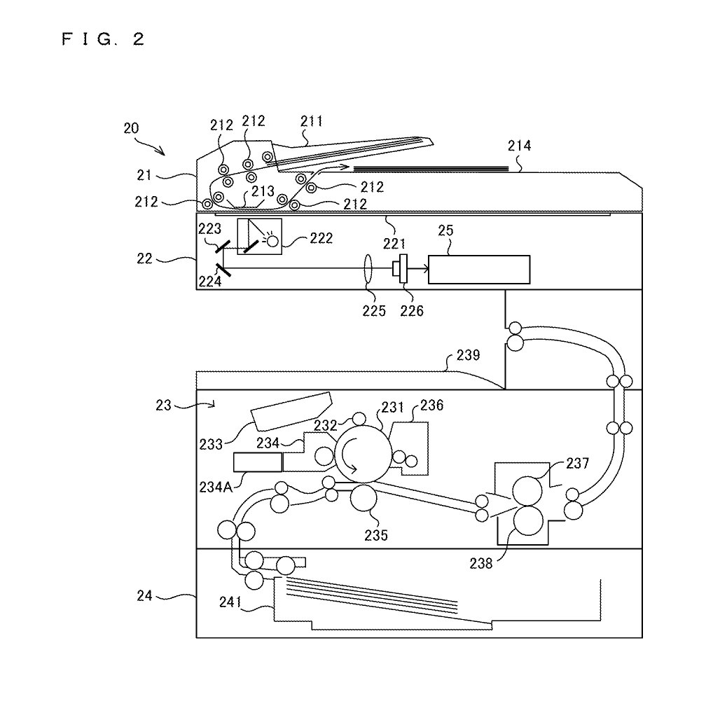

As shown in FIGS. 1 and 2, the first image forming apparatus 20 includes an ADF 21, an image reading portion 22, an image forming portion 23, a sheet feed portion 24, a control portion 25, an operation display portion 26, a first communication portion 27, a second communication portion 28, a third communication portion 29, and a storage portion 30. The first image forming apparatus 20 is a multifunction peripheral having a plurality of functions such as a scan function, a facsimile function, a copy function and the like, as well as a printer function to form an image based on image data. In addition, the first image forming apparatus 20 may be an image forming apparatus such as a printer that can print the print data transmitted from the information processing apparatus 10.

As shown in FIG. 2, the ADF 21 is an automatic document sheet feeding device and includes a document sheet setting portion 211, a plurality of conveying rollers 212, a document sheet pressing 213, and a sheet discharge portion 214. In the ADF 21, the plurality of conveying rollers 212 are driven by motors (not shown) such that a document sheet placed on the document sheet setting portion 211 is conveyed to pass an image data reading position where the image data is read by the image reading portion 22, and then conveyed to the sheet discharge portion 214. With this configuration, the image reading portion 22 can read image data from a document sheet conveyed by the ADF 21.

As shown in FIG. 2, the image reading portion 2 includes a document sheet table 221, a reading unit 222, mirrors 223, 224, an optical lens 225, and a CCD (Charge Coupled Device) 226. The document sheet table 221 is a document sheet placing portion provided on the upper surface of the image reading portion 22. The reading unit 222 includes an LED light source and a mirror, and is driven by a motor (not shown) to move in the sub scanning direction (the left-right direction in FIG. 2). The LED light source includes a number of white LEDs arranged along the main scanning direction (the depth direction in FIG. 2). The mirror reflects, toward the mirror 223, light which was irradiated by the LED light source and reflected on the surface of the document sheet at the reading position on the document sheet table 221. The light reflected on the mirror is guided into the optical lens 225 by the mirrors 223, 224. The optical lens 225 condenses incident light and makes the condensed light incident on the CCD 226. The CCD 226 includes a photoelectric converting element or the like, wherein the photoelectric converting element inputs an electric signal, which corresponds to the amount of light incident from the optical lens 225, into the control portion 25 as image data of the document sheet.

The image forming portion 23 is an image forming portion adopting the electrophotography and executes an image forming process (print process) based on the image data which is read by the image reading portion 22 or input from the information processing apparatus 10 or the like. Specifically, as shown in FIG. 2, the image forming portion 23 includes a photoconductor drum 231, a charging device 232, an exposure device (LSU) 233, a developing device 234, a transfer roller 235, a cleaning device 236, a fixing roller 237, a pressure roller 238, and a discharge tray 239. In the image forming portion 23, an image is formed in the following procedure on a paper sheet supplied from a sheet feed cassette 241 that is attachable/detachable to/from the sheet feed portion 24, and the paper sheet with the image formed thereon is discharged onto the discharge tray 239.

First, the charging portion 232 charges the surface of the photoconductor drum 231 uniformly into a certain potential. Next, the exposure device 233 irradiates the surface of the photoconductor drum 231 with light based on the image data. With this operation, an electrostatic latent image corresponding to the image data is formed on the surface of the photoconductor drum 231. Then the electrostatic latent image on the photoconductor drum 231 is developed (made visible) as a toner image by the developing device 234. It is noted that the toner (developer) is supplied to the developing device 234 from a toner container 234A that is attachable/detachable to/from the image forming portion 23. Subsequently, the toner image formed on the photoconductor drum 231 is transferred to a paper sheet by the transfer roller 235. The print sheet is then conveyed to pass through between the fixing roller 237 and the pressure roller 238, where the toner image having been transferred to the print sheet is heated by the fixing roller 237 so as to be fused and fixed to the print sheet. It is noted that the toner remaining on the surface of the photoconductor drum 231 is removed by the cleaning device 236.

The control portion 25 includes control equipment (not shown) such as CPU, ROM, RAM, EEPROM, or the like. The CPU is a processor for executing various types of arithmetic processes. The ROM is a nonvolatile storage portion in which various types of information such as control programs for causing the CPU to execute various types of processes are stored in advance. The RAM is a volatile storage portion, and the EEPROM is a nonvolatile storage portion. The RAM and the EEPROM are used as a temporary storage memory (working area) for the various types of processes executed by the CPU. The control portion 25 comprehensively controls the first image forming apparatus 20 by causing the CPU to execute the various types of control programs that have been stored in advance in the ROM. It is noted that the control portion 25 may be formed as an electronic circuit such as an integrated circuit (ASIC). Alternatively, the control portion 25 may be a control portion provided independently of a main control portion that comprehensively controls the first image forming apparatus 20.

The operation display portion 26 includes a display portion and an operation portion. The display portion is, for example, a liquid crystal display and displays various types of information based on control instructions from the control portion 25. The operation portion is composed of, for example, hard keys or a touch panel through which various types of information are input to the control portion 25 based on user's operations.

The first communication portion 27 executes a wireless data communication with an external communication apparatus such as the mobile terminal 40, based on a communication protocol defined by Bluetooth. For example, the first communication portion 27 can execute a Bluetooth wireless communication with the external communication apparatus in a communication range of approximately 10 m from the first communication portion 27, with a field intensity of so-called Class 2 (2.5 mW). It is noted that since the data communication method of Bluetooth is well-known, the description thereof is omitted here.

In the first image forming apparatus 20, a paring has been executed with the mobile terminal 40 in advance, wherein the paring is a procedure for authenticating a communication partner in the Bluetooth communication. During the paring, paring IDs, which are necessary for authenticating the respective communication partners, are exchanged. The paring ID of the mobile terminal 40 that was obtained by the first image forming apparatus 20 during the paring, is stored in the storage portion 30. After the completion of the paring, a data communication can be executed between the first image forming apparatus 20 and the mobile terminal 40.

The second communication portion 28 executes a wireless data communication with an external communication apparatus such as the mobile terminal 40, based on a communication protocol defined by NFC. Specifically, the second communication portion 28 can execute an NFC wireless communication with the external communication apparatus in a communication range of approximately 10 cm from the first image forming apparatus 20, in a frequency band of 13.56 MHz. It is noted that since the data communication method of NFC is well-known, the description thereof is omitted here.

The third communication portion 29 executes a wired or wireless data communication with an external communication apparatus such as the information processing apparatus 10, via the communication network 60. For example, the third communication portion 29 receives, from the information processing apparatus 10, the print data added with the transmission destination information having been set in advance, and stores the received transmission destination information into the storage portion 30. Here, the third communication portion 29 is an example of the receiving portion.

The storage portion 30 is a storage portion composed of SSD, HDD, or the like. The storage portion 30 stores the image data read by the image reading portion 22 or the print data transmitted from the information processing apparatus 10. In addition, the storage portion 30 stores the paring ID of the mobile terminal 40, in association with the transmission destination information, which is the electronic mail address of the mobile terminal 40. It is noted that in the case where the transmission destination information is a MAC address of the mobile terminal 40, the storage portion 30 stores the paring ID of the mobile terminal 40, in association with the MAC address of the mobile terminal 40.

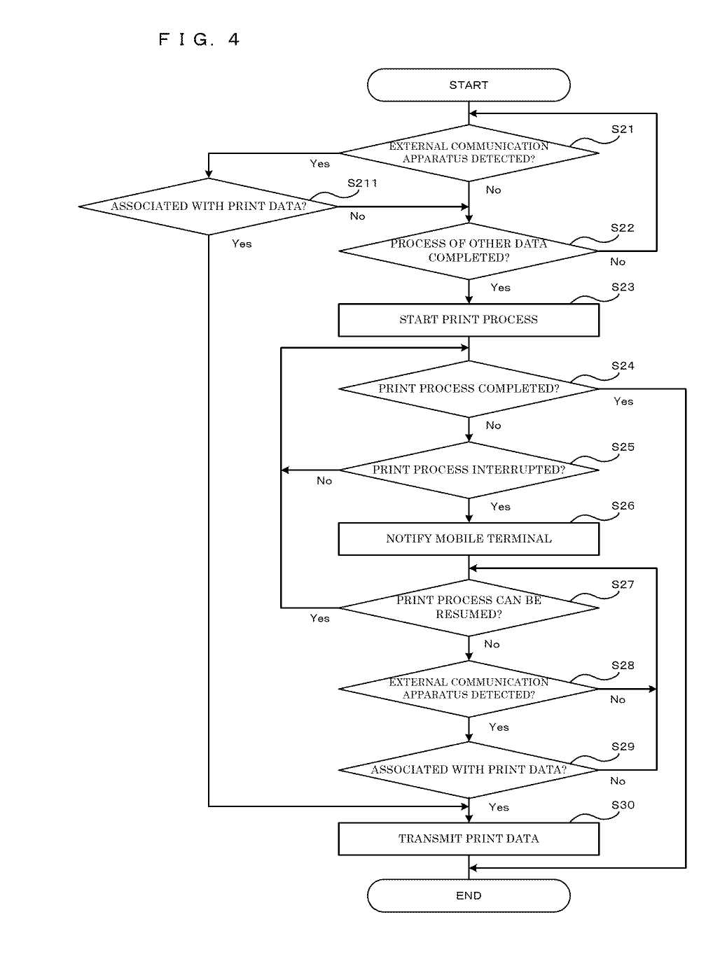

Furthermore, the storage portion 30 stores in advance a transmission control program for causing the CPU of the control portion 25 to execute a transmission control process (see the flowchart of FIG. 4) that is described below. It is noted that the transmission control program may be recorded in a computer-readable recording medium such as a CD, a DVD, a flash memory, or the like, and may be installed from the recording medium into a storage portion such as the storage portion 30.

As shown in FIG. 1, the control portion 25 includes a print control portion 251, a notification portion 252, a first detection portion 253, and a transmission control portion 254. The control portion 25 functions as the print control portion 251, notification portion 252, first detection portion 253, and transmission control portion 254 when it executes, by using the CPU, the transmission control program stored in the storage portion 30.

The print control portion 251 executes the print process based on the print data stored in the storage portion 30. Specifically, the print control portion 251 causes the image forming portion 23 to execute the print process by controlling the image forming portion 23. In addition, when the storage portion 30 stores a plurality of pieces of print data, the print control portion 251 executes print processes in a predetermined order. For example, the print control portion 251 executes the print processes in the order of the corresponding pieces of print data stored in the storage portion 30.

When a print process being executed by the print control portion 251 is interrupted due to a predetermined cause, the notification portion 252 sends a notification of the interruption to the mobile terminal 40 associated with the print data. For example, in the case where the transmission destination information added to the print data is the electronic mail address of the mobile terminal 40, the notification portion 252 sends a notification of the interruption of the print process and the predetermined cause thereof, to the mobile terminal 40 by transmitting an electronic mail to, as the destination, each of the electronic mail addresses added to all pieces of print data stored in the storage portion 30. It is noted that, in the case where the transmission destination information is the MAC address of the mobile terminal 40, the notification portion 252 sends a message indicating the interruption of the print process and the predetermined cause thereof, to the mobile terminal 40 that is identified by the MAC address added to the print data. Here, the predetermined cause is, for example, a paper jam in the image forming portion 23 or a system error of the first image forming apparatus 20. It is noted that the predetermined cause may include paper exhaustion in the sheet feed portion 24, toner exhaustion in the image forming portion 23, or the like.

The first detection portion 253 detects the mobile terminal 40 that is associated with the print data, in a predetermined communication range. Specifically, the first detection portion 253 detects the mobile terminal 40 that is associated with the print data, based on the transmission destination information added to the print data. For example, when an external communication apparatus that can communicate by NFC exists in an NFC communication range, the first detection portion 253 obtains the paring ID from the external communication apparatus. The first detection portion 253 then detects the mobile terminal 40 associated with the print data, by determining that the external communication apparatus is the mobile terminal 40 associated with the print data, based on the match of the electronic mail address associated with the obtained paring ID with the electronic mail address added to the print data. It is noted that the communication range is a range in which the second communication portion 28 can execute an NFC wireless communication with the external communication apparatus. In this example, the communication range is a range of approximately 10 cm. Here, the communication range in the NFC communication is an example of the predetermined communication range.

Here, the information obtained by the first detection portion 253 from the external communication apparatus through the NFC communication is not limited to the paring ID as far as it is information stored in the storage portion 30 in association with the transmission destination information. For example, in the case where the transmission destination information is the electronic mail address of the mobile terminal 40, and the storage portion 30 stores the MAC address of the mobile terminal 40 in association with the electronic mail address of the mobile terminal 40, the first detection portion 253 may obtain the MAC address of the external communication apparatus through the NFC communication.

When a predetermined transmission condition is satisfied, the transmission control portion 254 transmits the print data to the mobile terminal 40 that has been associated with the print data in advance. In addition, the transmission control portion 254 transmits the print data to the mobile terminal 40 that is identified based on the transmission destination information added to the print data. Specifically, the transmission condition is that the first detection portion 253 detects the mobile terminal 40 associated with the print data. In that case, the transmission control portion 254 transmits the print data, which is associated with the mobile terminal 40, to the mobile terminal 40 detected by the first detection portion 253. For example, the transmission control portion 254 transmits the print data to the mobile terminal 40 detected by the first detection portion 253, by using a Bluetooth wireless communication. It is noted that, with regard to the print data that is currently processed in the print process by the print control portion 251, the transmission control portion 254 transmits only not-processed part of the print data to the mobile terminal 40.

Here, as another configuration, when the first detection portion 253 detects the mobile terminal 40 associated with the print data, the transmission control portion 254 may transmit an electronic mail and the print data attached thereto, to the electronic mail address added to the print data, as the destination. Furthermore, as still another configuration, when the transmission destination information is a MAC address, the transmission control portion 254 may transmit the print data based on a communication protocol such as the FTP, to the mobile terminal 40 that is identified on the communication network 60 by the MAC address added to the print data.

[Mobile Terminal 40]

As shown in FIG. 1, the mobile terminal 40 includes a control portion 41, an operation display portion 42, a first communication portion 43, a second communication portion 44, a third communication portion 45, and a storage portion 46. The mobile terminal 40 is a mobile communication terminal carried by the user or the like, such as, for example, a smartphone, a mobile telephone, a tablet terminal, a notebook computer, a PDA, or the like.

The control portion 41 includes control equipment (not shown) such as CPU, ROM, RAM, EEPROM, or the like. The CPU is a processor for executing various types of arithmetic processes. The ROM is a nonvolatile storage portion in which various types of information such as control programs for causing the CPU to execute various types of processes are stored in advance. The RAM is a volatile storage portion, and the EEPROM is a nonvolatile storage portion. The RAM and the EEPROM are used as temporary storage memories (working areas) for the various types of processes executed by the CPU. The control portion 41 comprehensively controls the mobile terminal 40 by causing the CPU to execute the various types of control programs that have been stored in advance in the ROM or the storage portion 46. It is noted that the control portion 41 may be formed as an electronic circuit such as an integrated circuit (ASIC). Alternatively, the control portion 41 may be a control portion provided independently of a main control portion that comprehensively controls the mobile terminal 40.

The operation display portion 42 includes a display portion and an operation portion. The display portion is, for example, a liquid crystal display and displays various types of information based on control instructions from the control portion 41. The operation portion is composed of, for example, hard keys or a touch panel through which various types of information are input to the control portion 41 based on user's operations. It is noted that the operation display portion 42 can display an image that indicates the contents of the print data that has been transmitted by the transmission control portion 254 of the first image forming apparatus 20. Here, the operation display portion 42 is an example of the display portion.

The first communication portion 43 executes a communication process with an external communication apparatus such as the first image forming apparatus 20, based on a communication protocol defined by Bluetooth. For example, the first communication portion 43 can execute a Bluetooth wireless communication with the external communication apparatus in a communication range of approximately 10 m from the mobile terminal 40, with a field intensity of so-called Class 2, as is the case with the first image forming apparatus 20. Here, the mobile terminal 40 has executed the paring with the first image forming apparatus 20 in advance, and the paring ID of the first image forming apparatus 20 has been stored in the storage portion 46.

The second communication portion 44 executes a communication process with an external communication apparatus such as the first image forming apparatus 20, based on a communication protocol defined by NFC. Specifically, the second communication portion 44 can execute an NFC wireless communication with the external communication apparatus in a communication range of approximately 10 cm from the mobile terminal 40, in a frequency band of 13.56 MHz, as is the case with the first image forming apparatus 20.

The third communication portion 45 executes a wireless data communication with an external communication apparatus such as the first image forming apparatus 20 and the second image forming apparatuses 50, via the communication network 60.

The storage portion 46 is a nonvolatile storage portion such as a flash memory, and data can be read therefrom and written thereto by the control portion 41. The storage portion 46 stores the paring ID of the first image forming apparatus 20. In addition, the storage portion 46 stores the print data transmitted from the first image forming apparatus 20.

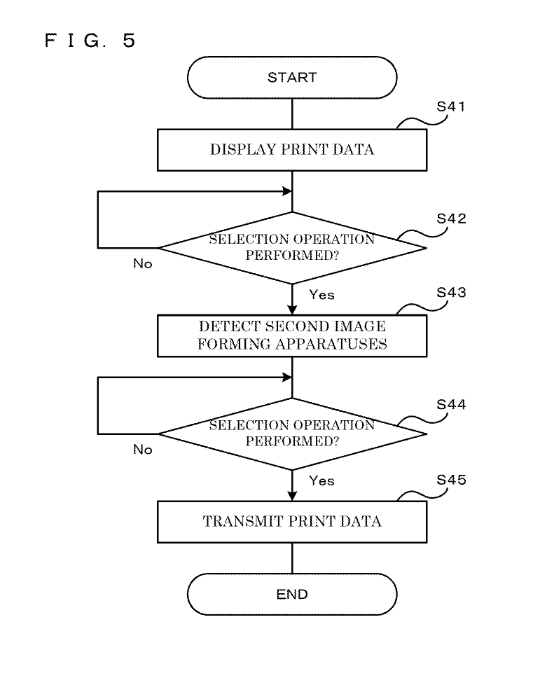

Furthermore, a second transmission program is stored in the storage portion 46 in advance, wherein the second transmission program is used to cause the CPU of the control portion 41 to execute a second transmission process (see the flowchart of FIG. 5) that is described below. It is noted that the second transmission program may be recorded in a computer-readable recording medium such as a CD, a DVD, a flash memory, or the like, and may be installed from the recording medium into a storage portion such as the storage portion 46.

As shown in FIG. 1, the control portion 41 includes a second detection portion 411 and a second transmission portion 412. The control portion 41 functions as the second detection portion 411 and the second transmission portion 412 when it executes, by using the CPU, the second transmission program stored in the storage portion 46.

The second detection portion 411 detects one or more second image forming apparatuses 50 that can execute the print process of the print data transmitted by the transmission control portion 254 of the first image forming apparatus 20. For example, the second detection portion 411 detects one or more second image forming apparatuses 50 in a LAN that can be accessed by the mobile terminal 40.

The second transmission portion 412 transmits the print data to a second image forming apparatus 50 which is selected, by a predetermined selection operation, from among the one or more second image forming apparatuses 50 detected by the second detection portion 411. For example, after the second detection portion 411 detects one or more second image forming apparatuses 50, the control portion 41 displays the detected one or more second image forming apparatuses 50 on the operation display portion 42. The user then selects a second image forming apparatus 50 from among the one or more second image forming apparatuses 50 displayed on the operation display portion 42, by operating the touch panel. The second transmission portion 412 then transmits the print data to the selected second image forming apparatus 50. Here, the selection operation with use of the touch panel for selecting one among the second image forming apparatuses 50 displayed on the operation display portion 42, is an example of the predetermined selection operation.

[Second Image Forming Apparatuses 50]

The second image forming apparatuses 50 are image forming apparatuses that can execute the print process of the print data transmitted from the mobile terminal 40. For example, the second image forming apparatuses 50 are each a multifunction peripheral having a plurality of functions such as a scan function, a facsimile function, a copy function and the like, as well as a printer function to form an image based on the image data. In addition, the second image forming apparatuses 50 may include an image forming apparatus such as a printer that can print the print data transmitted from the mobile terminal 40. The second image forming apparatus 50 has at least a configuration corresponding to the image forming portion 23, control portion 25, and third communication portion 29 of the first image forming apparatus 20, and executes a print process of the print data transmitted from the mobile terminal 40.

Meanwhile, there may be a case where a user, who is performing printing by using the image forming system 100, would like to complete the printing within an assumed time period because the next schedule, such as a meeting or an outing, is approaching. In that case, if the print process is interrupted by, for example, a failure such as a paper jam in the first image forming apparatus 20, the printing may not be completed within the time period that the user has assumed, and the user has trouble in going to the next schedule. This also applies to the case where, in the first image forming apparatus 20, a preceding print process of another user is delayed and takes a long time.

On the other hand, the image forming system 100 according to an embodiment of the present disclosure can meet the user's request to complete printing within an assumed time period. Specifically, in the image forming system 100, the information processing apparatus 10 executes the first transmission process, and the print data is transmitted to the first image forming apparatus 20. When a predetermined transmission condition is satisfied during the transmission control process executed by the first image forming apparatus 20, print data, which is in the middle of the print process or waiting to be processed in the print process by the first image forming apparatus 20, is transmitted to the mobile terminal 40. The mobile terminal 40 then executes the second transmission process, thereby the print data received from the first image forming apparatus 20 is transmitted to one of the second image forming apparatuses 50 that can execute the print process of the print data. The following describes the first transmission process, transmission control process, and second transmission process.

[First Transmission Process]

First, an example of procedures of the first transmission process executed by the control portion 11 in the information processing apparatus 10 is described with reference to FIG. 3. Here, S11, S12, . . . represent the processing procedures (steps) executed by the control portion 11. It is noted that the control portion 11 executes the first transmission process when the user of the information processing apparatus 10 has input, on the operation display portion 12, an operation instructing to print the print data in the first image forming apparatus 20.

<Step S11>

In step S11, the control portion 11 displays a setting screen on the operation display portion 12 for inputting the transmission destination information and print conditions, such as the number of printing, for the printing of the print data. For example, the transmission destination information is the electronic mail address of the mobile terminal 40.

<Step S12>

In step S12, the control portion 11 determines whether or not, on the setting screen displayed on the operation display portion 12 in the step S11, the user's operation of inputting the transmission destination information and the print conditions has completed. For example, when the user has operated an operation key instructing to transmit the print data displayed on the operation display portion 12, the control portion 11 determines that the user's input operation has completed.

Here, upon determining that the user's operation of inputting the transmission destination information and the print conditions has completed (Yes side at S12), the control portion 11 allows the process to proceed to step S13. On the other hand, upon determining that the user's operation of inputting the transmission destination information and the print conditions has not completed (No side at S12), the control portion 11 waits at the step S12 for the user's input operation to complete.

<Step S13>

In step S13, the control portion 11 generates a thumbnail image that indicates the contents of the print data. The thumbnail image is displayed on the mobile terminal 40 such that the contents of the print data can be confirmed in a second transmission process executed by the mobile terminal 40, wherein the second transmission process is described below.

<Step S14>

In step S14, the control portion 11 converts the data format of the print data into the PDL (Page Description Language) format, in which the first image forming apparatus 20 can execute the print process.

<Step S15>

In step S15, the control portion 11 adds, together with the thumbnail image generated in the step S13, the transmission destination information and the print conditions input by the user on the setting screen, to the print data whose data format has been converted in the step S14.

<Step S16>

In step S16, the control portion 11 transmits, to the first image forming apparatus 20, the print data to which the transmission destination information, the print conditions, and the thumbnail image were added in the step S15. Here, the process in the step S16 is executed by the first transmission portion 111 of the control portion 11.

As described above, in the first transmission process executed by the information processing apparatus 10, the transmission destination information is added to the print data that is transmitted to the first image forming apparatus 20. It is noted that the control portion 11 may store the transmission destination information, which was input on the setting screen, into the storage portion 14, and automatically add the transmission destination information stored in the storage portion 14 to the print data during the first transmission process that is executed subsequently. This reduces the operation labor of the user in inputting the transmission destination information on the setting screen.

[Transmission Control Process]

Next, an example of procedures of the transmission control process executed by the control portion 25 in the first image forming apparatus 20 is described with reference to FIG. 4. It is noted that the control portion 25 executes the transmission control process when the print data is received from the information processing apparatus 10. In addition, the control portion 25 executes the transmission control process for each of received pieces of print data.

<Step S21>

First, in step S21, the control portion 25 determines whether or not an external communication apparatus associated with the paring ID registered in advance in the storage portion 30 has been detected. Specifically, when an external communication apparatus that can communicate by NFC exists in the NFC communication range, the control portion 25 obtains the paring ID from the external communication apparatus. Subsequently, when it is confirmed that the obtained paring ID has been stored in the storage portion 30, the control portion 25 determines that an external communication apparatus associated with the paring ID has been detected.

Here, upon determining that an external communication apparatus associated with the paring ID has been detected (Yes side at S21), the control portion 25 allows the process to proceed to step S211. On the other hand, upon determining that an external communication apparatus associated with the paring ID has not been detected (No side at S21), the control portion 25 allows the process to proceed to step S22.

<Step S211>

In step S211, the control portion 25 determines whether or not the external communication apparatus detected in the step S21 is the mobile terminal 40 associated with the print data. Specifically, the control portion 25 determines that the external communication apparatus is the mobile terminal 40 associated with the print data when the electronic mail address stored in the storage portion 30 in association with the paring ID of the external communication apparatus detected in the step S21 matches the electronic mail address added to the print data.

Here, upon determining that the detected external communication apparatus is the mobile terminal 40 associated with the print data (Yes side at S211), the control portion 25 allows the process to proceed to step S30. On the other hand, upon determining that the detected external communication apparatus is not the mobile terminal 40 associated with the print data (No side at S211), the control portion 25 allows the process to proceed to step S22. It is noted that the processes of the steps S21 and S211 are executed by the first detection portion 253 of the control portion 25.

<Step S22>

In step S22, the control portion 25 determines whether or not print process of all the other pieces of print data having priorities in order have been completed.

Here, upon determining that print process of all the other pieces of print data having priorities in order have been completed (Yes side at S22), the control portion 25 allows the process to proceed to step S23. On the other hand, upon determining that print process of all the other pieces of print data having priorities in order have not been completed (No side at S22), the control portion 25 allows the process to proceed to step S21.

<Step S23>

In step S23, the control portion 25 starts the print process of the print data. It is noted that, before executing the print process, the control portion 25 converts the data format of the print data from the PDL format into the bitmap format. Here, the process of the step S23 is an example of the print step, and is executed by the print control portion 251 of the control portion 25.

<Step S24>

In step S24, the control portion 25 determines whether or not the print process of the print data started in the step S23 has been completed.

Here, upon determining that the print process of the print data has been completed (Yes side at S24), the control portion 25 ends the transmission control process. On the other hand, upon determining that the print process of the print data has not been completed (No side at S24), the control portion 25 allows the process to proceed to step S25.

<Step S25>

In step S25, the control portion 25 determines whether or not the print process of the print data started in the step S23 has been interrupted due to the predetermined cause.

Here, upon determining that the print process of the print data has been interrupted due to the predetermined cause (Yes side at S25), the control portion 25 allows the process to proceed to step S26. On the other hand, upon determining that the print process of the print data has not been interrupted due to the predetermined cause (No side at S25), the control portion 25 allows the process to proceed to step S24, and monitors whether or not the print process is interrupted due to the predetermined cause until the print process is completed.

<Step S26>

In step S26, the control portion 25 sends a notification of the interruption of the print process due to the predetermined cause and the predetermined cause to the mobile terminal 40, by transmitting an electronic mail to, as the destination, each of the electronic mail addresses added to all pieces of print data stored in the storage portion 30. With this configuration, if the print process in the first image forming apparatus 20 is interrupted due to the predetermined cause, the user, who is located away from the first image forming apparatus 20, can determine whether or not to transmit the print data to the mobile terminal 40 depending on how the next schedule is approaching. Here, the process of the step S26 is executed by the notification portion 252 of the control portion 25.

<Step S27>

In step S27, the control portion 25 determines whether or not the print process of the print data can be resumed. Specifically, when the predetermined cause of the interruption of the print process has been eliminated in the first image forming apparatus 20, the control portion 25 determines that the print process of the print data can be resumed.

Here, upon determining that the print process of the print data can be resumed (Yes side at S27), the control portion 25 allows the process to proceed to step S24. On the other hand, upon determining that the print process of the print data cannot be resumed (No side at S27), the control portion 25 allows the process to proceed to step S28.

<Step S28>

In step S28, as in step S21, the control portion 25 determines whether or not an external communication apparatus associated with the paring ID registered in advance in the storage portion 30 has been detected.

Here, upon determining that an external communication apparatus associated with the paring ID has been detected (Yes side at S28), the control portion 25 allows the process to proceed to step S29. On the other hand, upon determining that an external communication apparatus associated with the paring ID has not been detected (No side at S28), the control portion 25 allows the process to proceed to step S27.

<Step S29>

In step S29, as in step S211, the control portion 25 determines whether or not the external communication apparatus detected in the step S28 is the mobile terminal 40 associated with the print data.

Here, upon determining that the detected external communication apparatus is the mobile terminal 40 associated with the print data (Yes side at S29), the control portion 25 allows the process to proceed to step S30. On the other hand, upon determining that the detected external communication apparatus is not the mobile terminal 40 associated with the print data (No side at S29), the control portion 25 allows the process to proceed to step S27. It is noted that the processes of the steps S28 and S29 are executed by the first detection portion 253 of the control portion 25.

<Step S30>

In step S30, the control portion 25 transmits the print data through a Bluetooth wireless communication to the mobile terminal 40 that was determined to be associated with the print data in the step S211 or the step S29. Here, in the case of transmitting the print data to the mobile terminal 40 that was determined to be associated with the print data in the step S29, the control portion 25 transmits only not-processed part of the print data. It is noted that when the data format of the print data has been converted into the bitmap format, the control portion 25 may convert the data format of the print data into the PDL format before transmitting the print data. This reduces the data amount of the print data to be transmitted to the mobile terminal 40, and thus reduces the data transmission time. Here, the process of the step S30 is an example of the transmission step, and is executed by the transmission control portion 254 of the control portion 25.

As described above, in the transmission control process executed by the first image forming apparatus 20, the user moves the mobile terminal 40 into an NFC communication range. This allows for the image data associated with the mobile terminal 40, which is in the middle of the print process or waiting to be processed in the print process by the first image forming apparatus 20, to be transmitted to the mobile terminal 40. As a result, the user can transmit the print data to the mobile terminal 40 at an arbitrary timing by performing an intuitive operation of holding the mobile terminal 40 over the first image forming apparatus 20. In addition, in the transmission control process, the print data is transmitted through a Bluetooth wireless communication. As a result, it is possible to transmit the print data at a high speed to the mobile terminal 40.

[Second Transmission Process]

Next, an example of procedures of the second transmission process executed by the control portion 41 of the mobile terminal 40 is described with reference to FIG. 5. It is noted that the control portion 41 executes the second transmission process when the user of the mobile terminal 40 has input, on the operation display portion 42, an operation instructing to print the print data transmitted from the first image forming apparatus 20.

<Step S41>

First, in step S41, the control portion 41 displays, on the operation display portion 42, an image that indicates the contents of the print data transmitted from the first image forming apparatus 20. For example, the control portion 41 displays, on the operation display portion 42, the thumbnail image that was added to the print data in the step S15 of the first transmission process. In addition, the control portion 41 may display an image that indicates the contents of the print data, based on the print data. Here, when a plurality of pieces of print data exist, the control portion 41 displays one or more images that indicate the contents of each of the plurality of pieces of print data. This enables the user to confirm the contents of the plurality of pieces of print data transmitted from the first image forming apparatus 20, and to select a piece of print data that is to be transmitted to the second image forming apparatuses 50 to be printed.

<Step S42>

In Step S42, the control portion 41 determines whether or not a selection operation was performed on the one or more images displayed on the operation display portion 42, that were displayed in the step S41 to indicate the contents of the one or more pieces of print data.

Here, upon determining that a selection operation was performed on the one or more images indicating the contents of the print data (Yes side at S42), the control portion 41 allows the process to proceed to step S43. On the other hand, upon determining that a selection operation was not performed on the one or more images indicating the contents of the print data (No side at S42), the control portion 41 waits at the step S42 for a selection operation to be performed on the one or more images indicating the contents of the print data.

<Step S43>

In Step S43, the control portion 41 detects one or more second image forming apparatuses 50 that can execute the print process of the print data. For example, the control portion 41 detects one or more second image forming apparatuses 50 in a LAN that can be accessed by the mobile terminal 40. Subsequently, the control portion 41 displays information, such as the names of the detected one or more second image forming apparatuses 50, on the operation display portion 42. Here, the process of the step S43 is executed by the second detection portion 411 of the control portion 41.

<Step S44>

In Step S44, the control portion 41 determines whether or not a selection operation was performed on the one or more second image forming apparatuses 50 displayed on the operation display portion 42, that were displayed in the step S43.

Here, upon determining that a selection operation was performed on the one or more second image forming apparatuses 50 displayed on the operation display portion 42 (Yes side at S44), the control portion 41 allows the process to proceed to step S45. On the other hand, upon determining that a selection operation was not performed on the one or more second image forming apparatuses 50 displayed on the operation display portion 42 (No side at S44), the control portion 41 waits at the step S44 for a selection operation to be performed on the one or more second image forming apparatuses 50 displayed on the operation display portion 42.

<Step S45>

In Step S45, the control portion 41 transmits the print data to the second image forming apparatus 50 selected in the step S44. Here, when the data format of the print data is the PDL format, there may be a case where the first image forming apparatus 20 and the second image forming apparatus 50 support different PDL formats. Thus, when the first image forming apparatus 20 and the second image forming apparatus 50 support different PDL formats, the control portion 41 converts the data format of the print data into the PDL format supported by the second image forming apparatus 50 and transmits the print data. Upon receiving the print data, the second image forming apparatus 50 executes the print process of the print data and outputs the printed matter. Here, the process of the step S45 is executed by the second transmission portion 412 of the control portion 41.

As described above, in the second transmission process executed by the mobile terminal 40, one or more second image forming apparatuses 50 that can execute the print process of the print data, which is received from the first image forming apparatus 20, are detected in a LAN that can be accessed by the mobile terminal 40. As a result, the user can print the print data in an arbitrary environment in which the mobile terminal 40 can access the LAN. In addition, in the second transmission process, even if the first image forming apparatus 20 and the second image forming apparatus 50 support different PDL formats, the data format of the print data is converted into the PDL format supported by the second image forming apparatus 50. This allows the user to print the print data without conscious of the difference in PDL format.

As described above, according to the image forming system 100, when the user holds the mobile terminal 40 over the first image forming apparatus 20, the print data associated with the mobile terminal 40, which is in the middle of the print process or waiting to be processed in the print process by the first image forming apparatus 20, is transmitted to the mobile terminal 40. With this configuration, when the print process in the first image forming apparatus 20 is interrupted due to a failure such as a paper jam, or because a preceding print process of another user in the first image forming apparatus 20 is delayed and takes a long time, the user can determine whether or not to transmit the print data to the mobile terminal 40 depending on how the next schedule is approaching. In addition, with the configuration where the print data is transmitted from the first image forming apparatus 20 to the mobile terminal 40, the user can freely select the time and location at which to resume printing of the print data.

### Other Embodiments

Meanwhile, the transmission condition for the transmission control portion 254 of the first image forming apparatus 20 to transmit the print data is not limited to the above-described condition that the mobile terminal 40 is detected. For example, the transmission condition may be that the first detection portion 253 detects the mobile terminal 40 associated with the print data, or may be that the print process performed by the print control portion 251 is interrupted due to the predetermined cause. With this configuration, when the print process performed in the first image forming apparatus 20 is interrupted due to the predetermined cause, the user does not need to go to the first image forming apparatus 20. This reduces the labor of the user.

In addition, the transmission condition may include a condition that the total number of printing of the other print data having priorities in order exceeds a predetermined upper-limit value. For example, the predetermined upper-limit value may be “100”. With this configuration, when it is apparent that a preceding print process of another user in the first image forming apparatus 20 is delayed and takes a long time, the user does not need to go to the first image forming apparatus 20. This reduces the labor of the user.

It is noted that the print data transmitted from the first image forming apparatus 20 to the mobile terminal 40 is not limited to the print data received from the information processing apparatus 10. For example, when a failure such as a paper jam occurs during execution of a copy process in the first image forming apparatus 20, the print process of the read image data is interrupted. The present disclosure is applicable to the read image data, as well. Specifically, the read image data may be transmitted to the mobile terminal 40 of the user, who had logged in the first image forming apparatus 20 when the copy process started to be executed.

Furthermore, the method for the mobile terminal 40 to transmit the print data to the second image forming apparatus 50 is not limited to the above-described method. For example, the second image forming apparatuses 50 may have a configuration that corresponds to the first communication portion 27 and the second communication portion 28 of the first image forming apparatus 20. In that case, the second detection portion 411 may detect a second image forming apparatus 50 that exists in a predetermined communication range, and the second transmission portion 412 may transmit the print data to the second image forming apparatus 50 detected by the second detection portion 411. Furthermore, the mobile terminal 40 and the second image forming apparatuses 50 may be connected with each other by a wired connection such that the print data can be transmitted therebetween.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a receiving portion configured to receive, from an information processing apparatus, print data to which predetermined transmission destination information has been added;
a print control portion configured to execute a print process based on the print data;
a first detection portion configured to detect a mobile terminal that exists in a predetermined communication range and is identified based on the transmission destination information added to the print data; and
a transmission control portion configured to, when the first detection portion detects the mobile terminal, transmit the print data, which is associated with the mobile terminal, to the mobile terminal.

2. The image forming apparatus according to claim 1, further comprising
a notification portion configured to, when the print process executed by the print control portion is interrupted due to a predetermined cause, send a notification thereof to the mobile terminal associated with the print data.

3. The image forming apparatus according to claim 1, wherein
when the print process executed by the print control portion is interrupted due to a predetermined cause, the transmission control portion transmits the print data to the mobile terminal that is identified based on the transmission destination information added to the print data.

4. The image forming apparatus according to claim 1, wherein
with regard to the print data that is currently processed in the print process by the print control portion, the transmission control portion transmits only not-processed part of the print data to the mobile terminal.

5. An image forming system comprising:
the image forming apparatus according to claim 1; and
an information processing apparatus including a first transmission portion configured to add, to the print data, the transmission destination information of the mobile terminal having been set in advance, and transmit the print data to the image forming apparatus.

6. The image forming system according to claim 5, further comprising
the mobile terminal that includes:
a second detection portion configured to detect one or more image forming apparatuses that can execute the print process of the print data transmitted by the transmission control portion; and
a second transmission portion configured to transmit the print data to an image forming apparatus selected by a predetermined selection operation from among the one or more image forming apparatuses detected by the second detection portion.

7. The image forming system according to claim 6, wherein
the mobile terminal further includes
a display portion configured to display an image that indicates contents of the print data transmitted by the transmission control portion.

8. An image forming method comprising:
a receiving step of receiving, from an information processing apparatus, print data to which predetermined transmission destination information has been added;
a printing step of executing a print process based on the print data;
a detecting step of detecting a mobile terminal that exists in a predetermined communication range and is identified based on the transmission destination information added to the print data; and
a transmitting step of, when the detecting step detects the mobile terminal, transmitting the print data, which is associated with the mobile terminal, to the mobile terminal.
